(19) United States
(12) Patent Application Publication
(10) Pub. No.: US 2020/0398131 A1
(43) Pub. Date: Dec. 24, 2020

(54) BALL-BUMPER ASSEMBLY FOR MINIATURE GOLF COURSE

(71) Applicant: Tom John APPLETON, Whitby (CA)

(72) Inventor: Tom John APPLETON, Whitby (CA)

(21) Appl. No.: 16/885,443

(22) Filed: May 28, 2020

Related U.S. Application Data
(60) Provisional application No. 62/865,159, filed on Jun. 22, 2019.

(51) Int. Cl. A63B 67/02; A63B 57/40; A63B 71/06; F21V 23/04; F21S 8/00; F21V 23/00; F21V 23/06; F21S 2/00

(52) U.S. Cl. CPC A63B 67/02; A63B 57/40; A63B 71/0622; F21V 23/0471; F21S 8/032; F21Y 2115/10; F21V 23/06; F21S 2/005; A63B 2207/02; A63B 2071/0694; A63B 2220/801; F21V 23/009

(57) ABSTRACT

An apparatus includes a bumper assembly configured to be securely positioned along a length of a perimeter of a miniature golf course having a ball cup configured to receive a golf ball therein. A light-emitting assembly is supported by the bumper assembly. The light-emitting assembly is configured to emit light externally from the bumper assembly. A ball-detection device configured to be positioned proximate to the ball cup of the miniature golf course. The ball-detection device is configured to transmit a detection signal indicating that the golf ball was received by the ball cup of the miniature golf course. A controller assembly is configured to be in electrical communication with the light-emitting assembly. The controller assembly is also configured to be in electrical communication with the ball-detection device.

### TECHNICAL FIELD

This document relates to the technical field of (and is not limited to) an apparatus including (for instance) (A) a bumper assembly configured to be securely positioned along a length of a perimeter of a miniature golf course having a ball cup configured to receive a golf ball therein, and/or (B) a controller assembly configured to be in electrical communication with a light-emitting assembly supported by a bumper assembly, etc., (and a method therefor).

### BACKGROUND

Miniature golf (also called mini golf, mini-putt, crazy golf, or putt-putt) is an offshoot of the sport of golf focusing solely on the putting aspect of its parent game. It is played on courses consisting of a series of holes (usually a multiple of 9) similar to its parent, but characterized by their short length (usually within 10 yards from the tee to the cup). The game uses artificial putting surfaces such as carpet, artificial turf and/or concrete, a geometric layout often requiring nontraditional putting lines such as bank shots, and artificial obstacles such as tunnels/tubes, ramps, forms (made of concrete, metal and/or fiberglass), and/or moving obstacles such as windmills. When miniature golf retains many of these characteristics but without the use of any props or obstacles, it is purely a mini version of its parent game.

### SUMMARY

It will be appreciated that there exists a need to mitigate (at least in part) at least one problem associated with the existing miniature golf courses (also called the existing technology). After much study of the known systems and methods with experimentation, an understanding (at least in part) of the problem and its solution have been identified (at least in part) and are articulated (at least in part) as follows:

To mitigate, at least in part, at least one problem associated with the existing technology, there is provided (in accordance with a major aspect) an apparatus. The apparatus includes and is not limited to (comprises) a synergistic combination of a bumper assembly, a light-emitting assembly, a ball-detection device, and a controller assembly. The bumper assembly is configured to be securely positioned along a length of a perimeter of a miniature golf course having a ball cup configured to receive a golf ball therein. The light-emitting assembly is supported by the bumper assembly. The light-emitting assembly is configured to emit light externally from the bumper assembly in response to the light-emitting assembly receiving a light-activation signal. The ball-detection device is configured to be positioned proximate to the ball cup of the miniature golf course. The ball-detection device is configured to transmit a detection signal indicating that the golf ball was received by the ball cup of the miniature golf course. The controller assembly is configured to be in electrical communication with the light-emitting assembly. The controller assembly is also configured to be in electrical communication with the ball-detection device.

To mitigate, at least in part, at least one problem associated with the existing technology, there is provided (in accordance with a major aspect) a method. The method includes and is not limited to (comprises) securely positioning a bumper assembly along a length of a perimeter of a miniature golf course having a ball cup configured to receive a golf ball therein, in which the light-emitting assembly is supported by the bumper assembly. The light-emitting assembly is configured to emit light externally from the bumper assembly in response to the light-emitting assembly receiving a light-activation signal. The method further includes positioning the ball-detection device proximate to the ball cup of the miniature golf course. The ball-detection device is configured to transmit a detection signal indicating that the golf ball was received by the ball cup of the miniature golf course. The method further includes (A) placing the controller assembly in electrical communication with the light-emitting assembly, and (B) placing the controller assembly in electrical communication with the ball-detection device.

To mitigate, at least in part, at least one problem associated with the existing technology, there is provided (in accordance with a major aspect) an apparatus. The apparatus includes and is not limited to (comprises) a controller assembly. The controller assembly is configured to be in electrical communication with a light-emitting assembly supported by a bumper assembly. The light-emitting assembly is configured to emit light externally from the bumper assembly in response to the light-emitting assembly receiving a light-activation signal. The bumper assembly is configured to be securely positioned along a length of a perimeter of a miniature golf course having a ball cup (the ball cup is configured to receive a golf ball therein). The controller assembly is also configured to be in electrical communication with a ball-detection device (the ball-detection device is configured to be positioned proximate to the ball cup of the miniature golf course). The ball-detection device is configured to transmit a detection signal indicating that the golf ball was received by the ball cup of the miniature golf course.

To mitigate, at least in part, at least one problem associated with the existing technology, there is provided (in accordance with a major aspect) a method. The method includes placing the controller assembly in electrical communication with a light-emitting assembly supported by a bumper assembly. The light-emitting assembly is configured to emit light externally from the bumper assembly in response to the light-emitting assembly receiving a light-activation signal. The bumper assembly is configured to be securely positioned along a length of a perimeter of a miniature golf course having a ball cup (the ball cup is configured to receive a golf ball therein). The method further includes placing the controller assembly in electrical communication with a ball-detection device (the ball-detection device is configured to be positioned proximate to the ball cup of the miniature golf course). The ball-detection device is configured to transmit a detection signal indicating that the golf ball was received by the ball cup of the miniature golf course.

Other aspects are identified in the claims. Other aspects and features of the non-limiting embodiments may now become apparent to those skilled in the art upon review of the following detailed description of the non-limiting embodiments with the accompanying drawings. This Summary is provided to introduce concepts in simplified form that are further described below in the Detailed Description. This Summary is not intended to identify potentially key features or possible essential features of the disclosed subject matter, and is not intended to describe each disclosed embodiment or every implementation of the disclosed subject matter. Many other novel advantages, features, and relationships will become apparent as this description proceeds. The figures and the description that follow more particularly exemplify illustrative embodiments.

### BRIEF DESCRIPTION OF THE DRAWINGS

The non-limiting embodiments may be more fully appreciated by reference to the following detailed description of the non-limiting embodiments when taken in conjunction with the accompanying drawings, in which:

FIG. 1 depicts a top view of an embodiment of a bumper assembly; and

FIG. 2, FIG. 3 and FIG. 4 depict perspective views (FIG. 2 and FIG. 3), and a top view (FIG. 4) of embodiments of the bumper assembly of FIG. 1; and

FIG. 5 and FIG. 6 depict end views of embodiments of the bumper assembly of FIG. 1; and

FIG. 7 depicts a top view of an embodiment of the bumper assembly of FIG. 1; and

FIG. 8, FIG. 9, FIG. 10 and FIG. 11 depict top views of embodiments of the bumper assembly of FIG. 1; and

FIG. 12, FIG. 13, FIG. 14, FIG. 15 and FIG. 16 depict schematic views (FIG. 12 and FIG. 13), side views (FIG. 14 and FIG. 15), and a perspective view (FIG. 16) of embodiments of components supported by (mounted to) the bumper assembly of FIG. 1; and

FIG. 17 depicts a schematic view of an embodiment of a controller assembly of the bumper assembly of FIG. 1.

The drawings are not necessarily to scale and may be illustrated by phantom lines, diagrammatic representations and fragmentary views. In certain instances, details unnecessary for an understanding of the embodiments (and/or details that render other details difficult to perceive) may have been omitted. Corresponding reference characters indicate corresponding components throughout the several figures of the drawings. Elements in the several figures are illustrated for simplicity and clarity and have not been drawn to scale. The dimensions of some of the elements in the figures may be emphasized relative to other elements for facilitating an understanding of the various disclosed embodiments. In addition, common, and well-understood, elements that are useful in commercially feasible embodiments are often not depicted to provide a less obstructed view of the embodiments of the present disclosure.

### LISTING OF REFERENCE NUMERALS USED IN THE DRAWINGS

bumper assembly 102
first bumper assembly 104
second bumper assembly 106
light-emitting assembly 108
light-activation signal 109
ball-detection device 110
detection signal 111
controller assembly 112
control circuit 113
light controller 114
detection controller 116
coupling assembly 118
engagement feature 119
top connector hole 120
top surface 121
side connector hole 122
side wall 123
flat spot 124
end portion 125
end wall 126
end hole 128
working surface 129
connector 130
motion sensor 131
support block 132
end plate 134
power terminals 138
battery 139
power leads 140
power plug 141
plug 142
LED (light emitting diode) 143
electrical connector 144
perimeter 900
miniature golf course 902
ball cup 904
golf ball 906
golf club 908

### DETAILED DESCRIPTION OF THE NON-LIMITING EMBODIMENT(S)

The following detailed description is merely exemplary and is not intended to limit the described embodiments or the application and uses of the described embodiments. As used, the word “exemplary” or “illustrative” means “serving as an example, instance, or illustration.” Any implementation described as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure. The scope of the claim is defined by the claims (in which the claims may be amended during patent examination after the filing of this application). For the description, the terms “upper,” “lower,” “left,” “rear,” “right,” “front,” “vertical,” “horizontal,” and derivatives thereof shall relate to the examples as oriented in the drawings. There is no intention to be bound by any expressed or implied theory in the preceding Technical Field, Background, Summary or the following detailed description. It is also to be understood that the devices and processes illustrated in the attached drawings, and described in the following specification, are exemplary embodiments (examples), aspects and/or concepts defined in the appended claims. Hence, dimensions and other physical characteristics relating to the embodiments disclosed are not to be considered as limiting, unless the claims expressly state otherwise. It is understood that the phrase “at least one” is equivalent to “a”. The aspects (examples, alterations, modifications, options, variations, embodiments and any equivalent thereof) are described regarding the drawings. It should be understood that the invention is limited to the subject matter provided by the claims, and that the invention is not limited to the particular aspects depicted and described. It will be appreciated that the scope of the meaning of a device configured to be coupled to an item (that is, to be connected to, to interact with the item, etc.) is to be interpreted as the device being configured to be coupled to the item, either directly or indirectly. Therefore, “configured to” may include the meaning “either directly or indirectly” unless specifically stated otherwise.

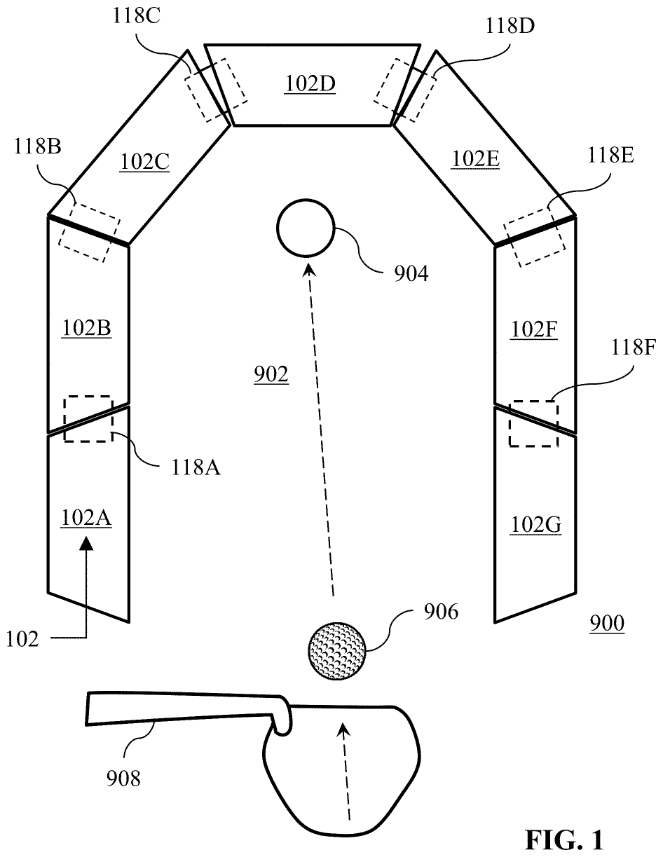

FIG. 1 depicts a top view of an embodiment of a bumper assembly 102.

Referring to the embodiment as depicted in FIG. 1, the bumper assembly 102 is configured to be positioned or placed on a perimeter 900 of a miniature golf course 902 having a ball cup 904 being configured to receive a golf ball 906 therein. A golf club 908 is moved or utilized by a user (not depicted) to strike the golf ball 906 so that the golf ball 906 may move toward, and into, the ball cup 904. The bumper assembly 102 may be a called an elongated bumper block. The bumper assembly 102 may be called a rail assembly. The bumper assembly 102 may be called a ball-bumper assembly. Preferably, the bumper assembly 102 includes a plurality of bumper assemblies (102A, 102B, 102C, 102D, 102E, 102F, 102G, etc.) positioned in an end-to-end arrangement. At least some of the plurality of bumper assemblies surround the ball cup 904. Each of a plurality of coupling assemblies (118A, 118B, 118C, 118D, 118E, 118F) is configured to connect (securely connect) a pair of adjacently-positioned bumper assemblies in an end-to-end arrangement.

Referring to the embodiment as depicted in FIG. 1, the bumper assembly 102 is (preferably) configured to keep the golf ball 906 on (within) the miniature golf course 902. The bumper assembly 102 may be made from any suitable material (plastic, wood, a clear polycarbonate material, etc.). The bumper assembly 102 may support a fluorescent print, etc. The bumper assembly 102 may be manufactured from a mold (plastic injection mold) for the plastic.

Referring to the embodiment as depicted in FIG. 1, the bumper assembly 102 is configured to be securely positioned along a length of a perimeter 900 of a miniature golf course 902 having a ball cup 904 being configured to receive a golf ball 906 therein.

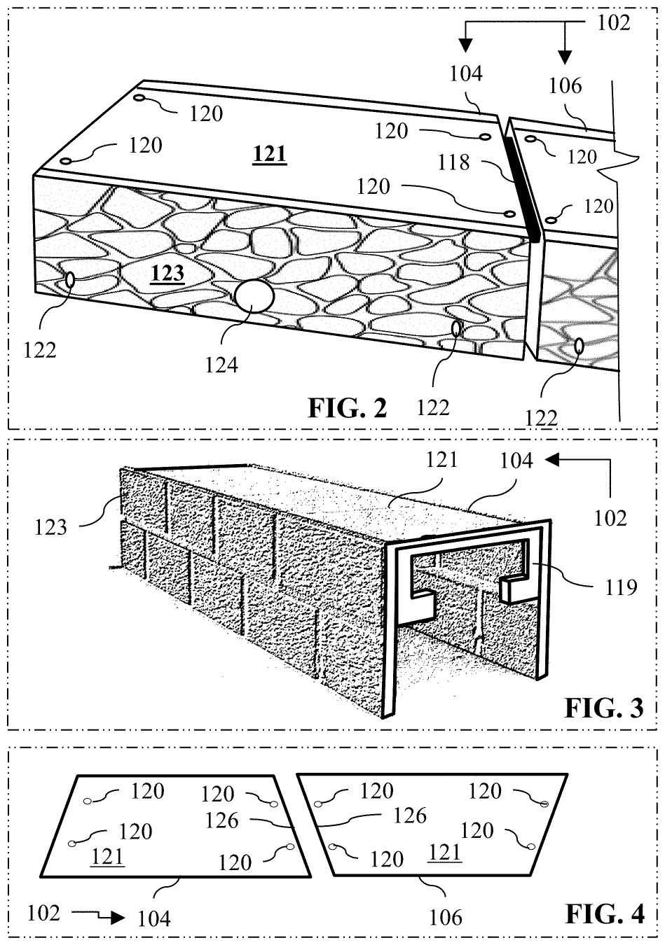

FIG. 2, FIG. 3 and FIG. 4 depict perspective views (FIG. 2 and FIG. 3) and a top view (FIG. 4) of embodiments of the bumper assembly 102 of FIG. 1.

Referring to the embodiment as depicted in FIG. 2, the bumper assembly 102 includes (and is not limited to) a first bumper assembly 104 and a second bumper assembly 106. The first bumper assembly 104 may be called a first ball-bumper assembly. The second bumper assembly 106 may be called a second ball-bumper assembly. The first bumper assembly 104 and the second bumper assembly 106 are configured to be connectable with each other (end to end or in an end-to-end relationship).

Referring to the embodiment as depicted in FIG. 2, the bumper assembly 102 further includes a coupling assembly 118. The coupling assembly 118 is configured to couple the first bumper assembly 104 and the second bumper assembly 106 together (with each other).

Referring to the embodiment as depicted in FIG. 2, the exterior side walls of the first bumper assembly 104 define or provide a textured appearance (such as, of a pattern of rocks, etc.). Preferably, the first bumper assembly 104 provides (defines) top connector holes 120 positioned at the corners (each corner) of the top surface 121 of the first bumper assembly 104. Preferably, the first bumper assembly 104 provides (defines) side connector holes 122 positioned along the bottom section of the side walls 123. Preferably, the first bumper assembly 104 provides (defines) a flat spot 124 for the location of a hole (to be formed) for passing electrical wiring therethrough. The flat spot 124 may define a line of weakness.

Referring to the embodiment as depicted in FIG. 3, the first bumper assembly 104 defines or provides an engagement feature 119 configured to engage the coupling assembly 118. The second bumper assembly 106 also includes an engagement feature (not depicted) similar to the engagement feature 119 of the first bumper assembly 104. Preferably, the coupling assembly 118 includes an elongated body, and the engagement feature 119 includes (defines) an opening configured to receive the elongated body. Preferably, the engagement feature 119 forms a U-shaped notched opening.

Referring to the embodiment as depicted in FIG. 4, the first bumper assembly 104 and the second bumper assembly 106 have end sections that define angled end walls 126.

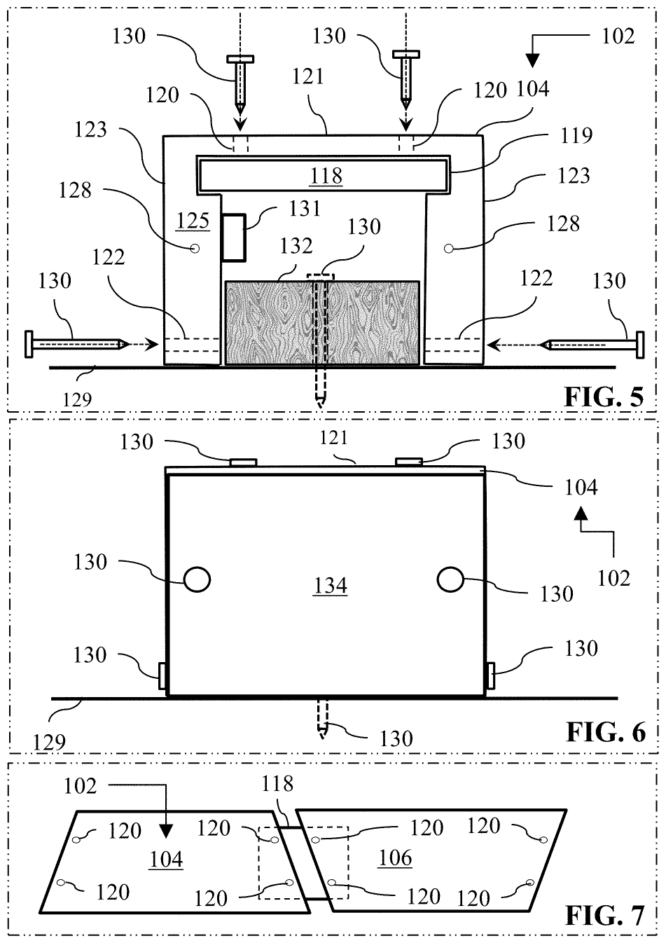

FIG. 5 and FIG. 6 depict end views of embodiments of the bumper assembly 102 of FIG. 1.

Referring to the embodiment as depicted in FIG. 5, the bumper assembly 102 is positioned on, or over, a support block 132, in which the support block 132 is secured (affixed) to a working surface 129 (the ground, etc.) via a connector 130. The side walls 123 of the bumper assembly 102 (or the first bumper assembly 104 or the second bumper assembly 106) define (provide) the side connector holes 122 (respectively). The connectors 130 (such as, screws, nails, etc.) are inserted into the side connector holes 122. The connectors 130 are configured to secure the bumper assembly 102 to the support block 132.

Referring to the embodiment as depicted in FIG. 5, the bumper assembly 102 includes an end portion 125. The engagement feature 119 is located on, or secured at, the end portion 125. The coupling assembly 118 is configured to receive (at least in part) the coupling assembly 118. The end portion 125 also provides a pair of spaced-apart end holes 128 (for use as depicted in FIG. 6).

Referring to the embodiment as depicted in FIG. 5, the top surface 121 of the bumper assembly 102 defines (provides) spaced-apart top connector holes 120. Connectors 130 are received in the top connector holes 120. The connectors 130 are configured to securely connect the top surface 121 of the bumper assembly 102 to the coupling assembly 118.

Referring to the embodiment as depicted in FIG. 6, an end plate 134 is positioned over the end portion 125 (depicted in FIG. 5), and the connector 130 is received in the pair of spaced-apart end holes 128 (depicted in FIG. 5), and the connector 130 is configured to securely connect the end plate 134 to the end portion 125 of the bumper assembly 102.

FIG. 7 depicts a top view of an embodiment of the bumper assembly 102 of FIG. 1.

Referring to the embodiment as depicted in FIG. 7, the coupling assembly 118 is received (at least in part) into the first bumper assembly 104 and the second bumper assembly 106. The coupling assembly 118 extends into (at least in part) the first bumper assembly 104 and the second bumper assembly 106. The degree of play between the components may be adjusted to permit the first bumper assembly 104 and the second bumper assembly 106 to be positioned at an angle relative to each other (if so desired).

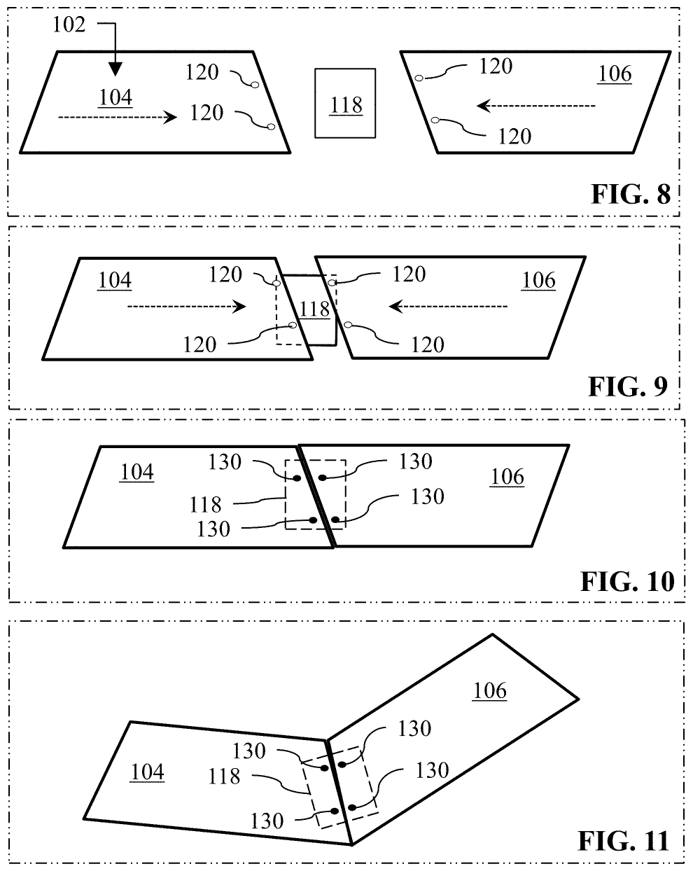

FIG. 8, FIG. 9, FIG. 10 and FIG. 11 depict top views of embodiments of the bumper assembly 102 of FIG. 1.

Referring to the embodiment as depicted in FIG. 8, the coupling assembly 118 is positioned between the first bumper assembly 104 and the second bumper assembly 106.

Referring to the embodiment as depicted in FIG. 9, the coupling assembly 118 is partly received by the first bumper assembly 104 and the second bumper assembly 106. The first bumper assembly 104 and the second bumper assembly 106 are moved toward each other in an end-to-end relationship. The end portions of the first bumper assembly 104 and the second bumper assembly 106 face each other.

Referring to the embodiment as depicted in FIG. 10, the first bumper assembly 104 and the second bumper assembly 106 contact at least a part of each other once they are moved toward each other in an end-to-end relationship. The end portions of the first bumper assembly 104 and the second bumper assembly 106 face each other. The coupling assembly 118 is held within (at least in part) the first bumper assembly 104 and the second bumper assembly 106.

Referring to the embodiment as depicted in FIG. 11, the end portions of the first bumper assembly 104 and the second bumper assembly 106 are angled relative to the elongated side walls of the first bumper assembly 104 and the second bumper assembly 106. This arrangement permits the first bumper assembly 104 and the second bumper assembly 106 to be aligned at an acute angle relative to each other.

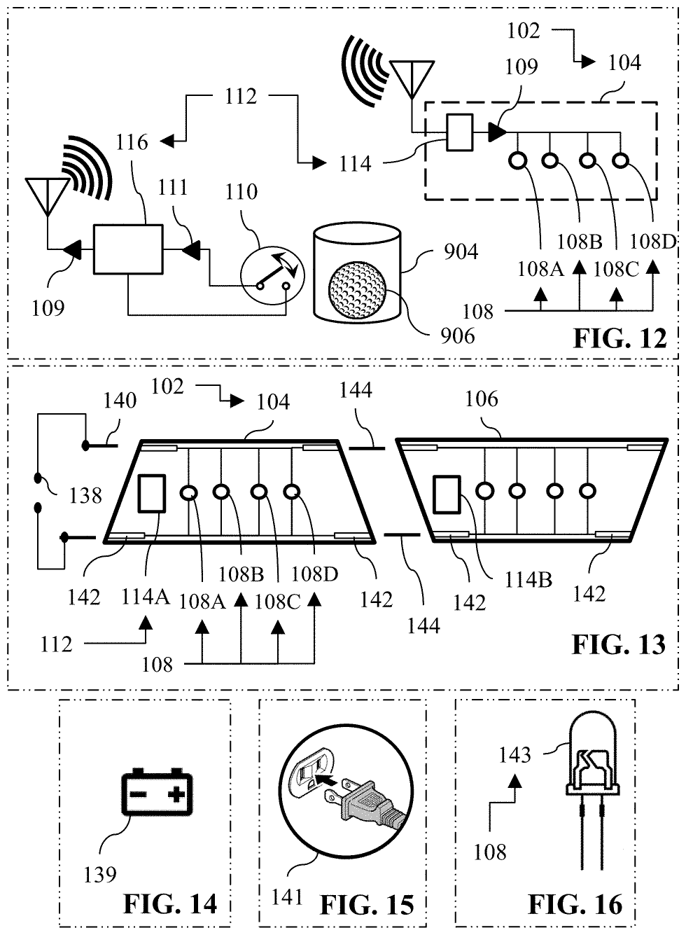

FIG. 12, FIG. 13, FIG. 14, FIG. 15 and FIG. 16 depict schematic views (FIG. 12 and FIG. 13), side views (FIG. 14 and FIG. 15), and a perspective view (FIG. 16) of embodiments of components supported by (mounted to) the bumper assembly 102 of FIG. 1.

Referring to the embodiment as depicted in FIG. 12, the light-emitting assembly 108 is supported by (mounted to) the bumper assembly 102 (such as, and not limited to, the first bumper assembly 104). Preferably, the light-emitting assembly 108 includes (and is not limited to) a collection of lamps or spaced-apart lamps (such as, Light Emitting Diodes or LEDs), etc. (as depicted in FIG. 15). The light-emitting assembly 108 is configured to emit light (of any color) externally from the bumper assembly 102 (such as, the first bumper assembly 104) (in response to the light-emitting assembly 108 receiving a light-activation signal 109). The light-emitting assembly 108 is configured to receive the light-activation signal 109. The light-activation signal 109 is configured to activate the light-emitting assembly 108 (once the light-activation signal 109 is received by the light-emitting assembly 108). For instance, the light-emitting assembly 108 may be mounted in the interior of the bumper assembly 102, and the bumper assembly 102 (such as the first bumper assembly 104) may include a light-transmissive housing configured to permit light from the light-emitting assembly 108 to exit from the bumper assembly 102. The controller assembly 112 (such as, a light controller 114) is configured to output (transmit) the light-activation signal 109 to the light-emitting assembly 108 (preferably under specific conditions or states). The light-activation signal 109 is configured to activate the emission of light from the light-emitting assembly 108 away from (externally from) the bumper assembly 102 (such as, the first bumper assembly 104) in response to the controller assembly 112 (or the light controller 114) inputting (receiving, input, either directly or indirectly) a detection signal 111 from a ball-detection device 110 (in which the ball-detection device 110 is positioned proximate to the ball cup 904).

Referring to the embodiment as depicted in FIG. 12, the side wall(s) of the bumper assembly 102 may be clear so that the user may view the LEDs (the light-emitting assembly 108) may be positioned within the interior of the bumper assembly 102 (provided the light from the light-emitting assembly 108 may escape exterior of the bumper assembly 102).

Referring to the embodiment as depicted in FIG. 12, the controller assembly 112 (such as, a light controller 114) is configured to turn on (activate) and turn off (deactivate) the light-emitting assembly 108 once the ball-detection device 110 has detected that the ball cup 904 has received the golf ball 906 (the ball is sunk into the cup). Alternatively, the controller assembly 112 (such as, a light controller 114) is configured to urge the light-emitting assembly 108 to emit a flash pattern (intermittently turn off and turn on with a predetermined duty cycle, change the color of light emitted (for the case where the LED is configured to emit differently colored light), etc.).

Referring to the embodiment as depicted in FIG. 12 and FIG. 5, a motion sensor 131 (also called an impact sensor, as depicted in FIG. 5) is mounted to (preferably mounted to the interior of) the bumper assembly 102. The motion sensor 131 is configured to detect that the golf ball 906 has contacted the bumper assembly 102.

The controller assembly 112 (such as, a light controller 114) is configured to turn on (activate) and turn off (deactivate), or emit a flash pattern (intermittently turn off and turn on with a predetermined duty cycle, change the color of light emitted (for the case where the LED is configured to emit differently colored light), etc., once the motion sensor 131 has detected that the golf ball 906 has contacted (struck) the bumper assembly 102.

Referring to the embodiment as depicted in FIG. 12, the light-emitting assembly 108 is supported by (mounted to) the bumper assembly 102 (such as, and not limited to, the first bumper assembly 104, etc.). Preferably, each bumper assembly (102A to 102G) as depicted in FIG. 1 includes a lamp assembly (or the lamps may be positioned in only some of the bumper assemblies as depicted in FIG. 1, as may be desired). The light-emitting assembly 108 is configured to emit light externally from the bumper assembly 102 (in response to the light-emitting assembly 108 receiving the light-activation signal 109).

Referring to the embodiment as depicted in FIG. 12, the ball-detection device 110 is positioned proximate (near) to the ball cup 904 of the miniature golf course 902 (as depicted in FIG. 1). The ball-detection device 110 may include a proximity sensor device (known and not further described here). A proximity sensor is a sensor able to detect the presence of nearby objects without any physical contact. A proximity sensor is configured to (A) emit an electromagnetic field or a beam of electromagnetic radiation (infrared, for instance), and (B) detect changes in the field or return signal. The object (such as, the golf ball 906 positioned in the ball cup 904) being sensed is referred to as the target of the proximity sensor. The ball-detection device 110 is configured to transmit (convey) a detection signal 111 (such as to the controller assembly 112 or to a detection controller 116, etc.), in which the detection signal 111 indicates that the golf ball 906 was received by the ball cup 904 of the miniature golf course 902.

Referring to the embodiment as depicted in FIG. 12, a controller assembly 112 (such as, the detection controller 116, etc.) is configured to be in electrical communication with (either directly or indirectly, either via wire or wirelessly) the light-emitting assembly 108 supported by the bumper assembly 102 (or the first bumper assembly 104, etc.). Preferably, the controller assembly 112 (such as, the detection controller 116, etc.) is configured to be in wireless electrical communication with the light-emitting assembly 108 (via an antenna, etc.). The controller assembly 112 is also configured to be in electrical communication with (either directly or indirectly) the ball-detection device 110 (which is positioned proximate to the ball cup 904 of the miniature golf course 902 of FIG. 1).

Referring to the embodiment as depicted in FIG. 12, the controller assembly 112 (or the detection controller 116) is further configured to input (receive, either directly or indirectly) the detection signal 111 from (provided by) the ball-detection device 110. The detection signal 111 is configured to indicate that the golf ball 906 was received by the ball cup 904 of the miniature golf course 902. The controller assembly 112 (or the detection controller 116) is further configured to output (transmit) (either directly or indirectly) the light-activation signal 109 to the light-emitting assembly 108 (that is, in response to the controller assembly 112 (or the detection controller 116) inputting (receiving, input) the detection signal 111 from, or issued by, the ball-detection device 110). The light-activation signal 109 is configured to activate the emission of light from the light-emitting assembly 108 externally from the bumper assembly 102. The light-activation signal 109 is configured to activate the light-emitting assembly 108 so that light may emit from the light-emitting assembly 108 externally from the bumper assembly 102.

Referring to the embodiment as depicted in FIG. 12, the controller assembly 112 (in accordance with a preferred embodiment) includes a synergistic combination of a light controller 114 and a detection controller 116 (which are preferably spaced apart from each other). The light controller 114 is supported by (mounted to) the bumper assembly 102. The light controller 114 is configured to be electrically connected to (directly or indirectly) the light-emitting assembly 108. The detection controller 116 is configured to be positioned in a spaced-apart relationship from, and externally from, the bumper assembly 102. The light controller 114 and the detection controller 116 are configured to be in electrical communication (directly or indirectly and/or a wired or wireless fashion) with each other. Preferably (as depicted in FIG. 12), the light controller 114 and the detection controller 116 are configured to be in wireless electrical communication with each other (such as via respective antennas, etc.).

Referring to the embodiment as depicted in FIG. 12, the detection controller 116 is configured to receive the detection signal 111 from the ball-detection device 110. The detection controller 116 is configured to transmit the light-activation signal 109 (preferably wirelessly) to the light controller 114 (that is, in response to the detection controller 116 receiving the detection signal 111 from the ball-detection device 110). The light controller 114 is configured to receive the light-activation signal 109 from the detection controller 116. It will be appreciated that the nature or the configuration of the light-activation signal 109 (whether received as an input to (or provided as an output from) the light controller 114) may vary as may be required for implementation purposes (whether utilized and an input signal or an output signal, etc.). The light controller 114 is configured to transmit the light-activation signal 109 to the light-emitting assembly 108 (that is, in response to the light controller 114 receiving the light-activation signal 109 from the detection controller 116).

Referring to the embodiment as depicted in FIG. 13, the power terminals 138 are configured to be selectively connectable to an electrical power source (as depicted in FIG. 14 or FIG. 15). The first bumper assembly 104 supports a first light controller 114A and the light-emitting assembly 108. The second bumper assembly 106 supports a second light controller 114B. Alternatively, the second light controller 114B and the light-emitting assembly 108 are not installed to the second bumper assembly 106, and the second bumper assembly 106 is configured to provide a pass-through circuit (for passing electrical power to another bumper assembly, etc.). Power leads 140 connect the power terminals 138 to the plugs 142 of the first bumper assembly 104. The first bumper assembly 104 includes input plugs 142 (input terminals or a set of power input terminals) and output plugs 142 (output terminals or a set of power output terminals), with an electrical circuit coupling the input power terminals with the output power terminals. An electrical connector 144 is configured to electrically connect the internal electrical circuit of the first bumper assembly 104 with the internal electrical circuit of the second bumper assembly 106.

Referring to the embodiment as depicted in FIG. 14, the power source includes (preferably) a battery 139 configured to be connected to the power terminals 138 of FIG. 13.

Referring to the embodiment as depicted in FIG. 15, the power source includes (preferably) a power plug 141 configured to connect alternating current (AC) to the power terminals 138 of FIG. 13.

Referring to the embodiment as depicted in FIG. 16, the light-emitting assembly 108 includes (preferably) at least one lamp or at least one LED 143 (such as, at least one or more Light Emitting Diodes or LEDs), etc.

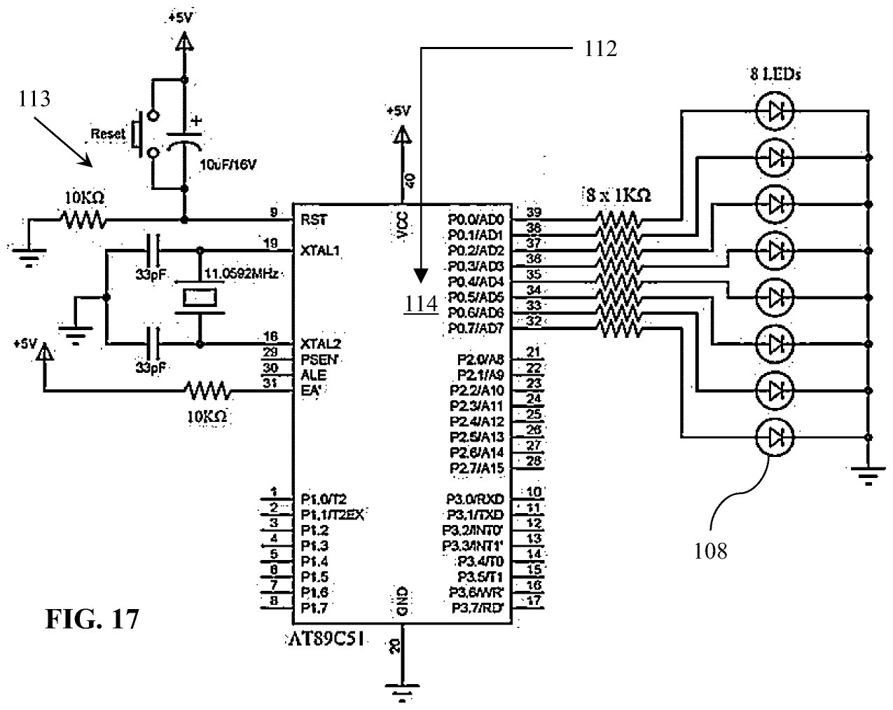

FIG. 17 depicts a schematic view of an embodiment of a controller assembly 112 (such as the detection controller 116 of the controller assembly 112) associated with the bumper assembly 102 of FIG. 1.

Referring to the embodiment as depicted in FIG. 17, the light-emitting assembly 108 includes (preferably) a plurality of spaced-apart Light Emitting Diodes (LEDs), etc., each made of a semiconducting material (to be mounted to the bumper assembly 102, such as the first bumper assembly 104 as depicted in FIG. 12 or FIG. 13), and any equivalent thereof. Preferably, the collection of LEDs of the light-emitting assembly 108 include a quantity of eight (8) LEDs.

Referring to the embodiment as depicted in FIG. 17, the detection controller 116 of the controller assembly 112 includes a control circuit 113 configured to interface the light-emitting assembly 108 with the detection controller 116. For instance, the detection controller 116 (preferably) includes the model 8051 microcontroller or the model AT89C51 microcontroller, both manufactured by the ATMEL (TRADEMARK) Corporation (based in the USA). The LEDs of the light-emitting assembly 108 may have a voltage drop of 1.7 volts (v) and a current capacity of about 10 milliamps (mA) to permit the LEDS to glow (emit light) at full intensity (this may be applied through the output pins of the model 8051 microcontroller). It is recommended to connect pull-up resistors (each preferably having a value of about one (1) Kilo ohms to all the pins PORT P0 of the model 8051 microcontroller); it will be appreciated that this connection is not shown in the circuit schematic as depicted in FIG. 17, for the sake of simplifying the schematic layout.

Referring to the embodiment as depicted in FIG. 17, the control circuit 113 includes (preferably) the following electrical components: (A) a quantity of eight (8) resistors (preferably, each having a value of about one Kilo ohms); (B) a crystal oscillator, preferably having a frequency or oscillating value of about 11.0592 megahertz (MHz); (C) a quantity of two (2) capacitors, preferably each having a value of about 33 picro Farads (pF); (D) a quantity of two (2) resistors, preferably each having a value of about 10 kilo ohms; (E) a quantity of one (1) capacitor, preferably having a value of about 10 microfarads (pf); (F) a push button; and (G) a power supply, preferably having an output of about five (5) volts (V).

Referring to the embodiment as depicted in FIG. 17, the model AT89C51 microcontroller belongs to the family of 8051 microcontrollers. The model AT89C51 microcontroller is an 8-bit microcontroller, having about four (4) Kilo Bytes (KB) of read-only memory (preferably, flash programmable and erasable read-only memory) and 128 bytes of random-access memory (RAM).

The model AT89C51 microcontroller has two 16 bit timers and/or counters, and supports UART communication protocol (UART stands for Universal Asynchronous Receiver/Transmitter). The model AT89C51 microcontroller has 40 pins, and there are four ports designated as Port P0, Port P1, Port P2, and Port P3. Port P0 does not have internal resistor pull-ups, while the other ports have internal resistor pull-ups.

Referring to the embodiment as depicted in FIG. 17, the LEDs are electrically connected (either directly or indirectly) to Port P0 of the model AT89C51 microcontroller. The model AT89C51 microcontroller is electrically connected to the crystal oscillator; the pins are connected to the ground through capacitors, preferably having a value of about 33 picofarads (pf). The LEDs provide semiconductor light sources that may have a cut-off voltage of 1.7 volts (V) and current capacity of about 10 milli Ampere (mA). When an LED is applied with its required voltage and current, the LED emits full intensity. The LED is similar to the normal PN diode but it emits energy in the form of light. The color of light depends on the band gap of the semiconductor. Thus, the LED is electrically connected to the model AT89C51 microcontroller with the help of a current limiting resistor, and the value of the resistor may be calculated using the following formula: R=(V−1.7)/10 mA, where (V) is the input voltage. The model AT89C51 microcontroller outputs (provides) a maximum voltage of five (5) volts (V). Thus, the value of current limiting resistor is calculated for this condition as having a value of about 330 Ohms. This current limiting resistor may be connected to either the cathode portion or the anode portion of the LED. Resistors, preferably having a value of about one (1) Kilo ohms (KI) are connected to the LEDs.

Referring to the embodiment as depicted in FIG. 17, the control circuit 113 may be stimulated by the following steps: (A) burn the code (controller logic) into the model AT89C51 microcontroller; (B) connect the LEDs to the Port P0 of the model AT89C51 microcontroller; (C) switch on the control circuit 113; (D) observe LEDs glowing (turned on or emitting light); and (E) switch off the control circuit 113.

Referring to the embodiment as depicted in FIG. 17, the algorithm (logic, control logic or control code) of the model AT89C51 microcontroller may be assembled according to the following steps: (A) include the “reg51.h” header file in the code (in embedded systems, it may be necessary to access (read from or write to) the hardware registers of the controller; these registers have a known address that may be defined in the data sheet, and each register has a name given to it, and the programmer uses these names while accessing the register); (B) write a function for producing delay used for a loop; (C) start the main function; (D) inside the while loop, write the condition to a port pin for making it logic high or low, and make it high for some delay, such as about 1000 microseconds; (E) make the port pin low, and give some delay of time such as about 1000 microseconds; (F) repeat this about eight (8) times using the loop; and (G) in another loop, represent the binary equivalent of the first 255 numbers using LEDs, and close the while loop and also the main loop.

Referring to the embodiment as depicted in FIG. 17, the following is an example of the code:

#include<reg51.h>
#define led P0
unsigned char i=0;
void delay (int);
void delay (int d)
{

unsigned char i=0;
for(;d>0;d−−)
{
for(i=250;i>0;i−−);
for(i=248;i>0;i−−);
}

}
void main( )
{

while(1)//// led blink
{

led=0xff;

delay(1000);
led=0x00;
delay(1000);
++i;
if(i==7)
{
i=0;
break;
}

}

while(1)//// binary equivalent representation of 1byte data
{
led=i++;
if(i==256)
{
i=0;
break;
}
delay(500);
}
while(1);

}

Referring to the embodiment as depicted in FIG. 17, the following is a description of the code logic: (A) for the first seven (7) seconds, the program shall execute the LED blink function (i.e., all the LEDs will turn ON and OFF in the interval of 1 second); (B) the program jumps to binary representation of one (1) byte data using eight (8) LEDs; and (C) for about every 500 milliseconds, the value may increment by one (1), and when it reaches a value of 255, then the program may start from the beginning.

The following is offered as further description of the embodiments, in which any one or more of any technical feature (described in the detailed description, the summary and the claims) may be combinable with any other one or more of any technical feature (described in the detailed description, the summary and the claims). It is understood that each claim in the claims section is an open ended claim unless stated otherwise. Unless otherwise specified, relational terms used in these specifications should be construed to include certain tolerances that the person skilled in the art would recognize as providing equivalent functionality. By way of example, the term perpendicular is not necessarily limited to 90.0 degrees, and may include a variation thereof that the person skilled in the art would recognize as providing equivalent functionality for the purposes described for the relevant member or element. Terms such as “about” and “substantially”, in the context of configuration, relate generally to disposition, location, or configuration that are either exact or sufficiently close to the location, disposition, or configuration of the relevant element to preserve operability of the element within the invention which does not materially modify the invention. Similarly, unless specifically made clear from its context, numerical values should be construed to include certain tolerances that the person skilled in the art would recognize as having negligible importance as they do not materially change the operability of the invention. It will be appreciated that the description and/or drawings identify and describe embodiments of the apparatus (either explicitly or inherently). The apparatus may include any suitable combination and/or permutation of the technical features as identified in the detailed description, as may be required and/or desired to suit a particular technical purpose and/or technical function. It will be appreciated that, where possible and suitable, any one or more of the technical features of the apparatus may be combined with any other one or more of the technical features of the apparatus (in any combination and/or permutation). It will be appreciated that persons skilled in the art would know that the technical features of each embodiment may be deployed (where possible) in other embodiments even if not expressly stated as such above. It will be appreciated that persons skilled in the art would know that other options would be possible for the configuration of the components of the apparatus to adjust to manufacturing requirements and still remain within the scope as described in at least one or more of the claims. This written description provides embodiments, including the best mode, and also enables the person skilled in the art to make and use the embodiments. The patentable scope may be defined by the claims. The written description and/or drawings may help to understand the scope of the claims. It is believed that all the crucial aspects of the disclosed subject matter have been provided in this document. It is understood, for this document, that the word “includes” is equivalent to the word “comprising” in that both words are used to signify an open-ended listing of assemblies, components, parts, etc. The term “comprising”, which is synonymous with the terms “including,” “containing,” or “characterized by,” is inclusive or open-ended and does not exclude additional, unrecited elements or method steps. Comprising (comprised of) is an “open” phrase and allows coverage of technologies that employ additional, unrecited elements. When used in a claim, the word “comprising” is the transmitory verb (transmitional term) that separates the preamble of the claim from the technical features of the invention. The foregoing has outlined the non-limiting embodiments (examples). The description is made for particular non-limiting embodiments (examples). It is understood that the non-limiting embodiments are merely illustrative as examples.

What is claimed is:

1. An apparatus, comprising:
a bumper assembly configured to be securely positioned along a length of a perimeter of a miniature golf course having a ball cup configured to receive a golf ball therein; and
a light-emitting assembly supported by the bumper assembly, and the light-emitting assembly configured to emit light externally from the bumper assembly in response to the light-emitting assembly receiving a light-activation signal; and
a ball-detection device configured to be positioned proximate to the ball cup of the miniature golf course, and the ball-detection device configured to transmit a detection signal indicating that the golf ball was received by the ball cup of the miniature golf course; and
a controller assembly configured to be in electrical communication with the light-emitting assembly, and the controller assembly also configured to be in electrical communication with the ball-detection device.

2. The apparatus of claim 1, wherein:
the controller assembly is further configured to:
input the detection signal from the ball-detection device, in which the detection signal is configured to indicate that the golf ball was received by the ball cup of the miniature golf course; and
output the light-activation signal to the light-emitting assembly in response to the controller assembly inputting the detection signal from the ball-detection device, in which the light-activation signal is configured to activate emission of light from the light-emitting assembly externally from the bumper assembly.

3. The apparatus of claim 2, wherein:
the controller assembly includes:
a light controller supported by the bumper assembly, and the light controller configured to be electrically connected to the light-emitting assembly; and
a detection controller configured to be positioned in a spaced-apart relationship from, and externally from, the bumper assembly; and
the light controller and the detection controller configured to be in electrical communication with each other.

4. The apparatus of claim 3, wherein:
the detection controller is configured to receive the detection signal from the ball-detection device; and
the detection controller is configured to transmit the light-activation signal to the light controller in response to the detection controller receiving the detection signal from the ball-detection device; and
the light controller is configured to receive the light-activation signal from the detection controller; and
the light controller is configured to transmit the light-activation signal to the light-emitting assembly in response to the light controller receiving the light-activation signal from the detection controller.

5. The apparatus of claim 1, wherein:
the bumper assembly includes a first bumper assembly and a second bumper assembly; and
the first bumper assembly and the second bumper assembly are configured to be connectable with each other; and
the light-emitting assembly is supported by the first bumper assembly, and the light-emitting assembly being configured to emit light externally from the first bumper assembly in response to the light-emitting assembly receiving the light-activation signal; and
the controller assembly is configured to output the light-activation signal to the light-emitting assembly, in which the light-activation signal activates emission of light from the light-emitting assembly away from the first bumper assembly once the controller assembly inputs the detection signal from the ball-detection device.

6. The apparatus of claim 5, wherein:
the controller assembly includes:
a light controller supported by the first bumper assembly, and the light controller being configured to be electrically connected to the light-emitting assembly; and
a detection controller configured to be positioned in a spaced-apart relationship from, and externally from, the first bumper assembly; and
the light controller and the detection controller are configured to be in electrical communication with each other.

7. The apparatus of claim 6, wherein:
the detection controller is configured to receive the detection signal from the ball-detection device; and
the detection controller is configured to transmit the light-activation signal to the light controller in response to the detection controller receiving the detection signal from the ball-detection device; and
the light controller is configured to receive the light-activation signal from the detection controller; and
the light controller is configured to transmit the light-activation signal to the light-emitting assembly in response to the light controller receiving the light-activation signal from the detection controller.

8. The apparatus of claim 5, wherein:
the bumper assembly further includes a coupling assembly configured to couple the first bumper assembly and the second bumper assembly together.

9. The apparatus of claim 1, wherein:
the bumper assembly provides top connector holes positioned at the corners of a top surface of the bumper assembly; and
the bumper assembly provides side connector holes positioned along a bottom section of side walls of the bumper assembly.

10. The apparatus of claim 1, wherein:
the bumper assembly includes a first bumper assembly and a second bumper assembly; and
the first bumper assembly includes a first engagement feature configured to engage a coupling assembly; and
the second bumper assembly includes a second engagement feature configured to engage the coupling assembly.

11. The apparatus of claim 1, wherein:
the bumper assembly includes a first bumper assembly and a second bumper assembly; and
the first bumper assembly includes a first engagement feature configured to engage a coupling assembly; and
the second bumper assembly includes a second engagement feature configured to engage the coupling assembly; and
the coupling assembly includes an elongated body; and
the first engagement feature includes an opening configured to receive the elongated body; and
the first engagement feature forms a U-shaped notched opening.

12. The apparatus of claim 1, wherein:
the bumper assembly includes a first bumper assembly and a second bumper assembly; and
the first bumper assembly and the second bumper assembly each have end sections that define angled end walls.

13. The apparatus of claim 1, wherein:
the bumper assembly is positionable on, or over, a support block, in which the support block is configured to be secured to a working surface via a connector; and
side walls of the bumper assembly provide side connector holes; and
connectors are insertable into the side connector holes, in which the connectors are configured to secure the bumper assembly to the support block.

14. The apparatus of claim 1, wherein:
the bumper assembly includes a first bumper assembly and a second bumper assembly; and
a top surface of the first bumper assembly provides spaced-apart top connector holes; and
connectors are received in the spaced-apart top connector holes; and
the connectors are configured to securely connect the top surface of the first bumper assembly to a coupling assembly, in which the coupling assembly is configured to couple the first bumper assembly and the second bumper assembly together.

15. The apparatus of claim 1, wherein:
the bumper assembly includes a first bumper assembly and a second bumper assembly; and
the first bumper assembly includes:
first plugs configured to be selectively electrically connectable to power terminals configured to be selectively connectable to an electrical power source, and the first plugs also being configured to be selectively electrically connectable to an internal electrical circuit; and
second plugs configured to be selectively electrically connectable to the first plugs of the second bumper assembly.

16. The apparatus of claim 1, further comprising:
a motion sensor is mounted to the bumper assembly, and the motion sensor is configured to detect that the golf ball has contacted the bumper assembly; and
the controller assembly is configured to activate and deactivate the light-emitting assembly once the motion sensor has detected that the golf ball has contacted the bumper assembly.

17. An apparatus, comprising:
a controller assembly configured to be in electrical communication with a light-emitting assembly supported by a bumper assembly, and the light-emitting assembly configured to emit light externally from the bumper assembly in response to the light-emitting assembly receiving a light-activation signal, and the bumper assembly configured to be securely positioned along a length of a perimeter of a miniature golf course having a ball cup configured to receive a golf ball therein; and
the controller assembly also configured to be in electrical communication with a ball-detection device configured to be positioned proximate to the ball cup of the miniature golf course, and the ball-detection device configured to transmit a detection signal indicating that the golf ball was received by the ball cup of the miniature golf course.

18. The apparatus of claim 17, wherein:
the controller assembly is further configured to:
input the detection signal from the ball-detection device, in which the detection signal is configured to indicate that the golf ball was received by the ball cup of the miniature golf course; and
output the light-activation signal to the light-emitting assembly in response to the controller assembly inputting the detection signal from the ball-detection device, in which the light-activation signal is configured to activate emission of light from the light-emitting assembly externally from the bumper assembly.

19. The apparatus of claim 18, wherein:
the controller assembly includes:
a light controller supported by the bumper assembly, and the light controller configured to be electrically connected to the light-emitting assembly; and
a detection controller configured to be positioned in a spaced-apart relationship from, and externally from, the bumper assembly; and
the light controller and the detection controller configured to be in electrical communication with each other.

20. The apparatus of claim 19, wherein:
the detection controller is configured to receive the detection signal from the ball-detection device; and
the detection controller is configured to transmit the light-activation signal to the light controller in response to the detection controller receiving the detection signal from the ball-detection device; and
the light controller is configured to receive the light-activation signal from the detection controller; and
the light controller is configured to transmit the light-activation signal to the light-emitting assembly in response to the light controller receiving the light-activation signal from the detection controller.
